(19) United States
(12) Patent Application Publication
(10) Pub. No.: US 2015/0103912 A1
(43) Pub. Date: Apr. 16, 2015

(54) METHOD AND APPARATUS FOR VIDEO ENCODING/DECODING BASED ON MULTI-LAYER

(71) Applicant: Electronics and Telecommunications Research Institute, Daejeon (KR)

(72) Inventors: Ha Hyun LEE, Seoul (KR); Jung Won KANG, Daejeon (KR); Jin Ho LEE, Daejeon (KR); Jin Soo CHOI, Daejeon (KR); Jin Woong KIM, Daejeon (KR)

(73) Assignee: Electronics and Telecommunications Research Institute, Daejeon (KR)

(21) Appl. No.: 14/511,333

(22) Filed: Oct. 10, 2014

(30) Foreign Application Priority Data
Oct. 11, 2013 (KR) 10-2013-0121133
Oct. 8, 2014 (KR) 10-2014-0135694

(51) Int. Cl. H04N 19/577

(52) U.S. Cl. CPC H04N 19/577; H04N 19/52; H04N 19/58; H04N 19/573
USPC 375/240.15

(57) ABSTRACT

Disclosed are a method and apparatus for video encoding/decoding based on a multi-layer. The method for video decoding to support a plurality of layers, includes: decoding Picture Order Count (POC) reset information indicating whether a POC value of a current picture is reset to 0; calculating the POC value of the current picture and respective POC values of a long-term reference picture and a short-term reference picture in a decoded picture buffer (DPB) referred by the current picture; and configuring a Reference Picture Set (RPS) for inter-prediction of the current picture based on the POC value of the long-term reference picture and the POC value of the short-term reference picture.

### CROSS-REFERENCE TO RELATED APPLICATIONS

This application claims the benefit of priority of Korean Patent Application No. 10-2013-0121133 filed on Oct. 11, 2013, and Korean Patent Application No. 10-2014-0135694 filed on Oct. 8, 2014, all of which are incorporated by reference in its entirety herein.

### BACKGROUND OF THE INVENTION

1. Field of the Invention

The present invention relates to video encoding and decoding technology, and more particularly to a method for equally setting Picture Order Count (POC) of pictures in the same access unit (AU) and a method for identifying a reference picture in a decoded picture buffer (DPB).

2. Related Art

In recent years, as a multimedia environment is established, various terminals and networks have been used so that various requests of a user are required.

For example, as a performance and computing capability of the terminal are variously changed, a supported performance has been diversified by devices. Further, an outer appearance of a network to which information is transmitted such as wired/wireless network, a form of transmitted information and an information amount and rate are diversified by functions. The user selects a terminal and a network to be used according to a desired function. Various spectrums of a terminal and a network have been provided to the user from an enterprise.

With regard to this point, in recent years, broadcasting having High Definition (HD) is extended and served all over the world as well as Korea so that users get used to an image having high resolution and high quality. Accordingly, many image service relation institutions are attempting to develop a next generation image device.

Further, as there is growing interest in Ultra High Definition (UHD) having a resolution of four times of HDTV in addition to the HDTV, a request for a technology of compressing and processing a high quality image having high resolution is gradually increased.

In order to compress and process the image, an inter-prediction technology of predicting a pixel value included in a current picture from a previous and/or next picture in time, an intra-prediction technology of predicting another pixel value included in a current picture using pixel information in a current picture, an entropy encoding technology of allocating a short code to a symbol having a high appearance frequency and allocating a long code to a symbol having a low appearance frequency may be used.

As described above, there is a need for various supported functions according to quality, the size, and a frame of a supported image by taking into consideration different terminals and networks and various requests of the users.

In this manner, scalability variously supporting quality, resolution, the size, and a frame rate, and a time point of an image is becoming an important function of a video format due to a heterogeneous communication network, various functions and types of terminals. In order to provide a service requested by the user in various environments based on a high efficiency video encoding method, there is a demand for a scalability function so that video encoding and decoding efficient in time, space, image quality, and time point sides are possible.

### SUMMARY OF THE INVENTION

Accordingly, an object of the present invention is to provide a method for equally setting POC of pictures in an AU in a scalable video coding including a plurality of layers, and an apparatus thereof.

The present invention provides a method for calculating POC values of reference pictures in a DPB referred by a current picture by resetting POC value of a current picture in a scalable video coding including a plurality of layers, and an apparatus thereof.

The present invention provides a method capable of signaling whether the POC value of a current picture is reset in a scalable video coding, and an apparatus thereof.

According to an aspect of the present invention, there is provided a method for video decoding to support a plurality of layers, the method including: decoding Picture Order Count (POC) reset information indicating whether a POC value of a current picture is reset to 0; calculating the POC value of the current picture and respective POC values of a long-term reference picture and a short-term reference picture in a decoded picture buffer (DPB) referred by the current picture; and configuring a Reference Picture Set (RPS) for inter-prediction of the current picture based on the POC value of the long-term reference picture and the POC value of the short-term reference picture.

According to another aspect of the present invention, there is provided a apparatus for video decoding to support a plurality of layers, the method including: a decoder to decode Picture Order Count (POC) reset information indicating whether a POC value of a current picture is reset to 0; and a predictor to calculate the POC value of the current picture and respective POC values of a long-term reference picture and a short-term reference picture in a decoded picture buffer (DPB) referred by the current picture, and to configure a Reference Picture Set (RPS) for inter-prediction of the current picture based on the POC value of the long-term reference picture and the POC value of the short-term reference picture.

The present invention provides a method capable of equally resetting POC values of pictures in the AU when the POCs in the pictures in the same AU are different from each other. Further, although the POC value of the current picture is reset, reference pictures in a decoding picture buffer referred by the current picture may be normally identified.

### BRIEF DESCRIPTION OF THE DRAWINGS

FIG. 1 is a block diagram illustrating a configuration of an apparatus for video encoding according to an embodiment of the present invention.

FIG. 2 is a block diagram illustrating a configuration of an apparatus for video decoding according to an embodiment of the present invention.

FIG. 3 is a conceptual diagram schematically illustrating a scalable video coding structure using a plurality of layers according to an embodiment of the present invention.

FIG. 4 is a flow chart schematically illustrating a method for resetting POC values of pictures in a scalable video coding structure including a plurality of layers and configuring a reference picture set for inter-prediction based on the reset POC values of pictures.

FIG. 5 is a diagram illustrating an example of a scalable video structure including a plurality of layers in order to describe a process for resetting POC values of pictures in an AU according to an embodiment of the present invention.

FIG. 6 is a diagram illustrating a process for resetting a POC value of reference pictures in a DPB based on POC reset information (for example, poc_reset_flag) indicating whether a POC value of a current picture is reset to 0 according to an embodiment of the present invention.

FIG. 7 is a diagram illustrating a method for calculating a POC value of long-term reference pictures according to an embodiment of the present invention.

### DETAILED DESCRIPTION OF THE INVENTION

Exemplary embodiments of the disclosure are described with reference to the accompanying drawings in detail. Accordingly, those skilled in the art can easily realize the present inventive concept. In the following description, if detailed description about well-known functions or configurations may make the subject matter of the disclosure unclear, the detailed description will be omitted.

It will be understood that when an element is referred to as being “connected” or “coupled” to another element, it can be directly connected or coupled to the other element or intervening elements may be present. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The terms “first” and “second” can be used to refer to various components, but the components may not be limited to the above terms. The terms will be used to discriminate one component from the other component. For instance, the first component may be referred to the second component and vice versa without departing from the right of the present invention.

Further, constituent elements included in an embodiment of the present invention are independently illustrated in order to express different characteristic functions, which do not mean to be configured in separated hardware or in one software configuration unit. That is, respective constituent elements are provided by listing the constituent elements, respectively. At least two of the constituent elements form one constituent element or one constituent element is divided into a plurality of constituent elements to perform functions. An integrated embodiment and a separated embodiment of respective constituent elements are included in the spirit and scope of the present invention that will fall within the spirit and scope of the principles of this disclosure.

In addition, some of the constituent elements may not be an essential constituent element for perform an essential function but may be a selective configuration for improving only the performance. The present invention may be implemented by including only essential constituent elements to implement the spirit and scope of the present invention except for constituent elements used to improve only the functions. A structure including only essential constituent elements except for a selective constituent element used to improve only the functions is included in the scope of the present invention.

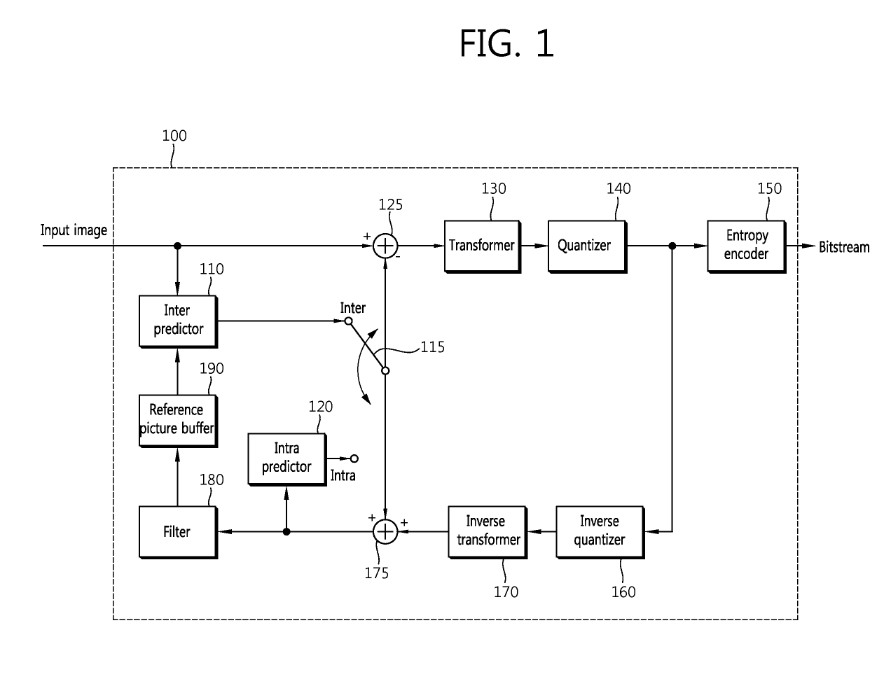

FIG. 1 is a block diagram illustrating a configuration of an apparatus for video encoding according to an embodiment of the present invention.

A scalable video encoding apparatus supporting a multi-layer structure may be implemented by extending a general video encoding apparatus having a single layer structure. The block diagram of FIG. 1 illustrates an example of the apparatus for video encoding which may be a base of the scalable encoding apparatus applicable to the multi-layer structure.

Referring to FIG. 1, an apparatus 100 for video encoding includes an inter-predictor 110, an intra-predictor 120, a switch 115, a subtractor 125, a transformer 130, a quantizer 140, an entropy encoder 150, an inverse quantizer 160, an inverse transformer 170, an adder 175, and a filter 180, and a reference picture buffer 190.

The apparatus 100 for video encoding may encode an input image in an intra-mode or an inter-mode to output a bitstream. In a case of the intra-mode, the switch 115 may be switched to an intra. In a case of the inter-mode, the switch 115 may be switched to an inter. Intra-prediction means prediction in a screen, and inter-prediction means prediction between screens. The apparatus 100 for video encoding may generate a predicted block with respect to an input block of an input image and encode residual between the input block and the predicted block. In this case, the input image may mean an original picture.

In a case of the intra-mode, the intra-predictor 120 may use a sample value of previously encoded/decoded block around a current block as a reference sample. The intra-predictor 120 may perform spatial prediction using the reference sample to generate predicted samples with respect to the current block.

In a case of the inter mode, the inter-predictor 110 may obtain a motion vector specifying a reference block with the least difference from an input block (current block) in a reference picture stored in a reference picture buffer 190 in a motion prediction process. The inter-predictor 110 may generate a predicted block with respect to the current block by performing motion compensation using a motion vector and the reference picture in the reference picture buffer 190.

In a case of a multi-layer structure, inter-prediction applied to the inter mode may include inter-layer prediction. The inter-predictor 110 may sample a picture of a reference layer to configure an inter-layer reference picture, and add the inter-layer reference picture to a reference picture list to perform inter-layer prediction. Reference relation between layers may be signaled through information specifying dependency between layers.

Meanwhile, when a current layer picture and a reference layer picture have the same size, sampling applied to the reference layer picture may signify generation of a reference sample by sampling duplication from the reference layer picture. When the current layer picture and the reference layer picture have different resolutions, sampling applied to the reference layer picture may signify upsampling.

For example, in a case of different resolution between layers, an inter-layer reference picture may be configured by ups ampling a reconstructed picture of a reference layer between layers supporting scalability regarding resolution.

Configuration of the inter-layer reference picture may be determined by taking into consideration an encoding cost using a certain picture of a layer. The apparatus for video encoding may transmit information specifying a layer including a picture to be used as an inter-layer reference picture to the apparatus for video decoding.

A picture used for predicting a current block in a layer referred in inter-layer rediction, that a reference layer may be a picture of the same AU(Access unit) as that of a current picture (prediction target picture in a current layer).

The subtractor 125 may generate a residual block based on a residual between the input block and the generated prediction block.

The transformer 130 may transform the residual block to output a transform coefficient. In this case, the transform coefficient may signify a coefficient value generated by transforming the residual block and/or the residual signal. Hereinafter, in the specification, a quantized transform coefficient level generated by quantizing the transform coefficient may refer to a transform coefficient.

When a transform skip mode is applied, the transformer 130 may omit transformation of the residual block.

The quantizer 140 quantizes the input transform coefficient according to a quantization parameter to output a quantized coefficient. The quantized coefficient may refer to a quantized transform coefficient level. In this case, the quantizer 140 may quantize the input transform coefficient using the quantization matrix.

The entropy encoder 150 may entropy-encode values calculated from the quantizer 140 or an encoding parameter value calculated by an encoding process. The entropy encoder 150 may entropy-encode information (for example, a syntax element and the like) for video decoding except for pixel information of video.

The encoding parameter is information necessary for encoding and decoding. The encoding parameter may include information which is encoded by the apparatus for video encoding and transferred to the apparatus for video decoding and information which may be derived during an encoding or decoding process.

For example, the encoding parameter may include values or statistics such as an intra/inter-prediction mode, a motion/movement vector, a reference image index, an encoding block pattern, presence of a residual signal, a transform coefficient, a quantized transform coefficient, a quantization parameter, a block size, and block division information.

The residual signal may signify a difference between an original signal and a predicted signal. In addition, the residual signal may signify a signal where the difference between the original signal and the predicted signal is transformed. Alternatively, the residual signal may signify a signal where the difference between the original signal and the predicted signal is transformed and quantized. The residual signal may refer to a residual block in a block unit.

When the entropy encoding is applied, a symbol is expressed by allocating the small number of bits to a symbol having a high generation probability and allocating the large number of bits to a symbol having a low generation probability so that the size of a bitstream with respect to encoding target symbols may be reduced. Accordingly, a compression performance of video encoding may be increased through the entropy encoding.

The entropy encoder 150 may use an encoding scheme such as exponential golomb, Context-Adaptive Variable Length Coding (CAVLC), and Context-Adaptive Binary Arithmetic Coding (CABAC) for the entropy-encoding. For example, the entropy encoder 150 may perform entropy encoding using a Variable Length Coding/Code (VLC) table. Further, the entropy encoder 150 may derive binarization scheme of a target symbol and a probability model of a target symbol/bin, and perform entropy encoding using the derived binarization scheme and probability model.

Since the apparatus for video encoding according to an embodiment of FIG. 1 performs an inter-prediction encoding, that is, prediction encoding between screens, there is a need to decode and store a current encoded image as a reference image. Accordingly, the quantized coefficient may be inversely quantized by the inverse quantizer 160 and may be inversely transformed by the inverse transformer 170. The inversely quantized and inversely transformed coefficient is added to a predicted block by the adder 175 so that a reconstructed block is generated.

The reconstructed block passes through the filter 180. The filter 180 may apply at least one of a deblocking filter, a Sample Adaptive Offset (SAO), an Adaptive Loop Filter (ALF) to the reconstructed block or the reconstructed picture. The filter 180 may refer to an adaptive in-loop filter. The deblocking filter may eliminate block distortion generated at a boundary between blocks. The SAO may add an appropriate offset value to a pixel value in order to compensate for a coding error. The ALF may perform filtering based on a value obtained by comparing a reconstructed image with an original image. The reconstructed block passed through the filter 180 may be stored in the reference picture buffer 190.

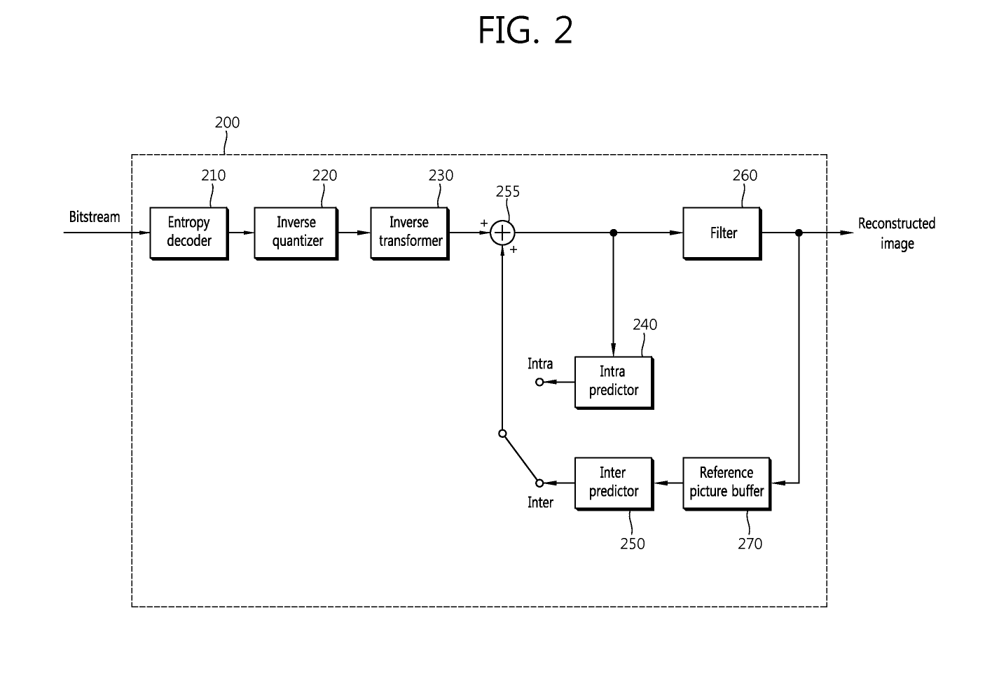

FIG. 2 is a block diagram illustrating a configuration of an apparatus for video decoding according to an embodiment of the present invention.

A scalable video decoding apparatus supporting a multi-layer structure may be implemented by extending a general video decoding apparatus having a single layer structure. The block diagram of FIG. 2 illustrates an example of the apparatus for video decoding which may be a base of the scalable encoding apparatus applicable to the multi-layer structure.

Referring to FIG. 2, an apparatus 200 for video decoding includes an entropy decoder 210, an inverse quantizer 220, an inverse transformer 230, an intra-predictor 240, an inter-predictor 250, an adder 255, a filter 260, and a reference picture buffer 270.

The apparatus 200 for video decoding may receive a bitstream output from an apparatus 100 for video encoding, decode the received bitstream in an intra-mode or an inter-mode to output a reconfigured image, that is, a reconstructed image.

In a case of the intra-mode, a switch may be switched to an intra. In a case of the inter-mode, the switch may be switch to an inter.

The apparatus 200 for video decoding may obtain a reconstructed residual block from the received bitstream to generate a predicted block, and generate a reconfigured block, that is, a reconstructed block by adding the reconstructed residual block to the predicted block.

The entropy decoder 210 may entropy-decode the received bitstream according to a probability distribution to output information such as a quantized coefficient and a syntax element.

The quantized coefficient is inversely quantized by the inverse quantizer 220 and is inversely transformed by the inverse transformer 230. The quantized coefficient is inversely quantized/inversely transformed so that a reconstructed residual block may be generated. In this case, the inverse quantizer 220 may apply a quantization matrix to the quantized coefficient.

In a case of the intra mode, the intra-predictor 240 may perform spatial prediction using a sample value of the decoded block around the current block, and generate predicted samples with respect to the current block.

In a case of an inter mode, the inter-predictor 250 may generate a predicted block with respect to the current block by performing motion compensation using a motion vector and a reference picture stored in the reference picture buffer 270.

In a case of a multi-layer, inter-prediction applied to the inter mode may include inter-layer prediction. The inter-predictor 250 may sample a picture of a reference layer to configure an inter-layer reference picture, and may perform inter-layer prediction by adding the inter-layer reference picture to a reference picture list. Reference relation between layers may be signaled through information specifying dependency between layers.

Meanwhile, when a current layer picture and a reference layer picture have the same size, sampling applied to the reference layer picture may signify generation of a reference sample by duplicating a sample from the reference layer picture. When resolution of the current layer picture is different from resolution of the reference layer picture, sampling applied to the reference layer picture may signify upsampling.

For example, in a case where resolution of the current layer picture is different from resolution of the reference layer picture, if inter-layer prediction is applied between layers supporting scalability with respect to resolution, the inter-layer reference picture may be configured by upsampling a reconstructed picture of the reference layer.

In this case, information specifying a layer including a picture to be used as the inter-layer reference picture may be transmitted to the apparatus for video decoding from the apparatus for video encoding.

In addition, a picture used for predicting a current block in a layer referred in inter-layer prediction, that a reference layer may be a picture of the same AU(Access unit) as that of a current picture (prediction target picture in a current layer).

The adder 255 adds the reconstructed residual block to the predicted block to generate a reconstructed block. In other words, the reconstructed sample or the reconstructed picture is generated by adding the residual sample to the predicted sample.

The reconstructed filter is filed by the filter 260. The filter 260 may apply at least one of a deblocking filter, an SAO, and an ALF to the reconstructed block or the reconstructed picture. The filter 260 outputs a modified or filtered reconstructed picture. The reconstructed image may be stored in the reference picture buffer 270 so that the reconstructed image may be used for inter-prediction.

In addition, the apparatus 200 for video decoding may further include a parsing unit (not shown) to parse information associated with an encoded image included in a bitstream. The parsing unit may include the entropy decoder 210 or may be included in the entropy decoder 210. Meanwhile, the parsing unit may be implemented as one constituent element of a decoder.

Although FIGS. 1 and 2 illustrate that one apparatus for video encoding/apparatus for video decoding encodes/decodes a multi-layer, this is illustrative purpose of convenience only. The apparatus for video encoding/apparatus for video decoding may be configured by layers.

In this case, the apparatus for video encoding/apparatus for video decoding of an higher layer may encode/decode a corresponding higher layer using information of an higher layer and information of a lower layer. For example, a predictor of the higher layer (inter-predictor) may perform intra-prediction or inter-prediction with respect to a current block using pixel information or picture information of the higher layer. Alternatively, the predictor of the higher layer may receive reconstructed picture information from the lower layer to perform inter-prediction (inter-layer prediction) with respect to a current block of the higher layer using the received reconstructed picture information. In this case, although prediction between layers is illustrative purpose only, the apparatus for video encoding/apparatus for video decoding may encode/decode a current layer using information of other layer regardless of configuration by layers or processing a multi-layer by one apparatus.

In the present invention, a layer may include a view. In this case, in a case of the inter-layer prediction, the higher layer is not simply performed using information of a lower layer, but inter-layer prediction may be performed using information of other layer between layers specified to have dependency due to information specifying dependency between the layers.

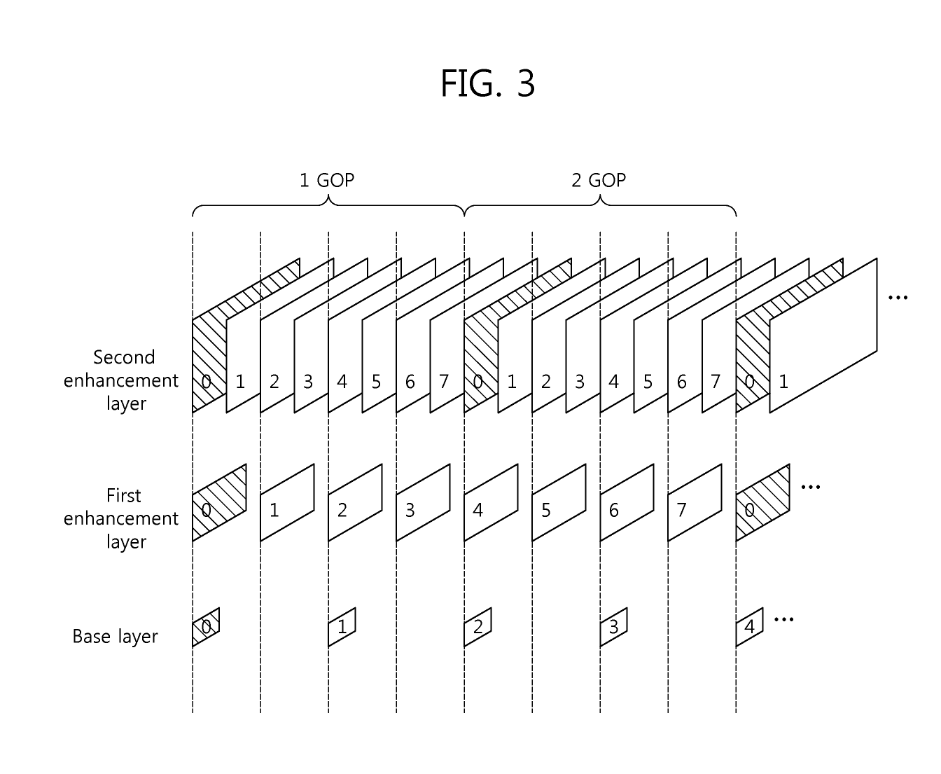

FIG. 3 is a conceptual diagram schematically illustrating a scalable video coding structure using a plurality of layers according to an embodiment of the present invention. In FIG. 3, a GOP represents a Group of Picture.

In order to transmit image data, there is a need for a transmission medium. The scalable video coding structure has a different performance by transmission media according to various network environments. A scalable video coding method applied to the various transmission media or a network environment may be provided.

A video coding method (hereinafter referred to ‘scalable coding’ or ‘scalable video coding’) of supporting scalability is a coding method of increasing encoding and decoding performances by removing redundancy between layers using texture information, motion information, and a residual signal between layers. A scalable video coding method may provide various scalabilities in spatial, temporal, image quality, (quality), and view aspects according to peripheral conditions such as a transmission bit rate, a transmission error rate, a system resource, and the like.

The scalable video coding may be performed using a multi-layered structure to provide a bitstream applicable to various network situations. For example, the scalable video coding structure may include a base layer to compress and process image data using a general image decoding scheme. The scalable video coding structure may include an enhancement layer to compress and process decoding information of the base layer and image data using the general image decoding scheme together.

The base layer may refer to a lower layer. The enhancement layer may refer to a higher layer. In this case, the lower layer may signify a layer supporting scalability lower than scalability of a specific layer. The higher layer may signify a layer supporting scalability higher than scalability of the specific layer. Further, a layer referred in encoding/decoding of another layer may refer to a reference layer. A layer encoded/decoded using another layer may refer to a current layer. The reference layer may be a lower layer lower than the current layer. The current layer may be a higher layer higher than the reference layer.

In this case, the layer signifies a set of images and bitstreams classified based on spatial (for example, image size), temporal (for example, decoding order, image output order, frame rate), image quality, complexity, view, and the like.

Referring to FIG. 3, for example, the base layer may be defined with standard definition (SD), a frame rate of 15 Hz, and a 1 Mbps bit rate. A first enhancement layer may be defined with high definition (HD), a frame rate of 30 Hz, and a 3.9 Mbps bit rate. A second enhancement layer may be defined with ultra-high definition (4K-UHD), a frame rate of 60 Hz, and a 27.2 Mbps bit rate.

The format, the frame rate, the bit rate, and the like are included in one embodiment, and may be changed as necessary. Further, the number of used layers is not limited to the present embodiment but may be changed according to a situation. For example, if a transmission bandwidth is 4 Mbps, a frame rate of the first enhancement layer HD may be transmitted with 15 Hz or less.

The scalable video coding scheme may provide temporal, spatial, image quality, and view scalabilities. In the specification, the scalable video coding has the same meaning as that of scalable video encoding in an encoding aspect. The scalable video coding has the same meaning as that of scalable video decoding in a decoding aspect.

Meanwhile, pictures in the same AU have the same POC value.

The POC may include a value capable of identifying pictures in the same layer, and a value indicating an output order of decoded pictures output from a decoded picture buffer (DPB).

The AU includes coded pictures having the same output time. For example, in a scalable video coding structure including a plurality of layers, when a picture A of a first layer and a picture B of a second layer have the same output time, the picture A of the first layer and the picture B of the second layer may be included in the same AU.

When the pictures in the same AU have different types of pictures, the pictures in the same AU may have different POC values. In this way, when the pictures in the same AU may have different POC values, there is a need for a method of setting the pictures in the AU to have the same POC value. In addition, there is a demand for a method capable of calculating POC values of reference pictures in the DPB in order to normally identify reference pictures in the DPB by resetting POC values of the pictures in the AU.

Hereinafter, the present invention provides a method of resetting POC values of pictures in an AU and POC values of reference pictures in a DPB to configure a Reference Picture Set (RPS) based on the reset POC values of pictures.

The present invention relates to encoding and decoding an image including a plurality of layers or views. The plurality of layers may include first, second, third, and n-th layers. The plurality of views may include first, second, third, and n-th views.

Hereinafter, an embodiment of the present invention describes an image including a first layer and a second layer for the purpose of convenience, but the same method is applicable to an image including layers more than two layers or views. Further, the first layer may be expressed as a lower layer, a base layer, or a reference layer. The second layer may be expressed as a higher layer, an enhancement layer, or a current layer.

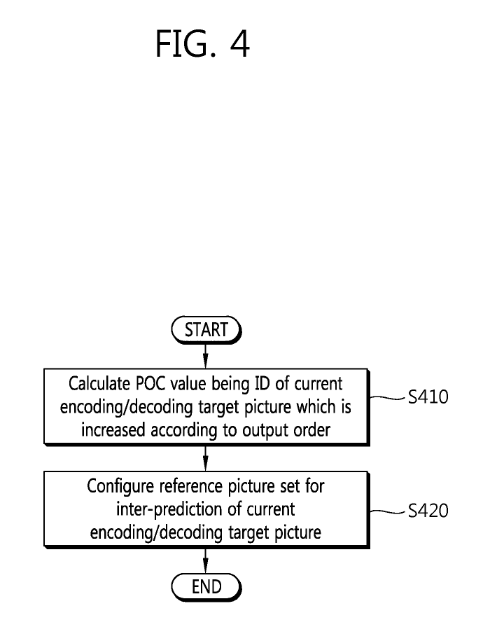

FIG. 4 is a flow chart schematically illustrating a method for resetting POC values of pictures in a scalable video coding structure including a plurality of layers and configuring a reference picture set for inter-prediction based on the reset POC values of pictures.

A method of FIG. 4 may be performed by the apparatus for video encoding shown in FIG. 1 and the apparatus for video decoding shown in FIG. 2.

Referring to FIG. 4, the apparatus for video encoding/apparatus for video decoding calculates a POC value of current encoding/decoding target picture (hereinafter referred to ‘current picture’) (S410).

As described above, the POC is an identifier to identify pictures in a layer having the same layer identifier nuh_layer_id in a coded video stream, and may be a value indicating an output order of pictures output from a DPB.

For example, if an order of the POC output from the DPB becomes late, the POC may be increased. In a case of the specific picture, the POC value may become 0.

The specific picture may be an Intra Random Access Point (IRAP) picture which is a first picture in a bitstream on a decoding order. A POC value of the IRAP picture may be 0. In other words, the IRAP picture may be decoded without decoding a picture prior to the IRAP picture in the decoding order, a POC value of the IRAP may be 0. The IRAP picture is a picture being a random access point and includes an intra (I) slice (slice decoded using only intra-prediction). The IRAP picture may include an instantaneous decoding refresh (IDR) picture, a clean random access (CRA) picture, or a Broken link access (BLA) picture. The IDR picture may include a first picture in a bitstream in a decoding order, and may be located at a middle in the bitstream. The CRA picture may include a first picture in the bitstream in the decoding order, and may be located at a middle of the bitstream for normal play. The BLA picture has a function and a characteristic similar to those of the CPA picture. If the coded picture is spliced or a middle of the bitstream is cut, the BLA picture is a random access point and refers to a picture located at a middle of the bitstream.

The POC value may be calculated using a Most Significant Bit (MSB) POC_MSB having the POC value and a Least Significant Bit (LSB) POC_LSB having the POC value.

In this case, the POC_LSB value may be transmitted from a slice segment header of a corresponding picture. The POC_MSB may be calculated by a following process according to a type of a corresponding picture.

(1-1) Case of a layer other than the IRAP picture, that a Non-IRAP picture

A POC_MSB value of the non-IRAP pictured may be calculated using a POC (prevPOC) of a picture (referred to as ‘previous picture’) having a temporal sub-layer identifier temporal_id of 0 (having a small difference from a POC of the current picture) close to a current picture, POC_LSB(prevPOCLSB) and POC_MSB(prevPOCMSB) of a previous picture using a LSB MaxPicOrderCntLsb of a maximum POC transmitted from Sequence Parameter Sets (SPS), and a POC_LSB(slice_pic_order_cnt_lsb) of the current picture signaled in a slice segment header of the current picture.

(1-2) Case of an IRAP picture

It may be assumed that a POC value of an IDR picture is always ‘0’.

When a first picture in the bitstream is a CRA picture or a BLA picture, a POC_MSB value of the CRA picture or the BLA picture is ‘0’. A POC_LSB(slice_pic_order_cnt_lsb) signaled in a slice segment header of the current picture may be used as a POC value of the CRA picture or the BLA picture.

When the CRA picture is not the first picture in the bitstream, the POC value of the CRA picture may be calculated to have the same as a POC of the Non-IRAP picture.

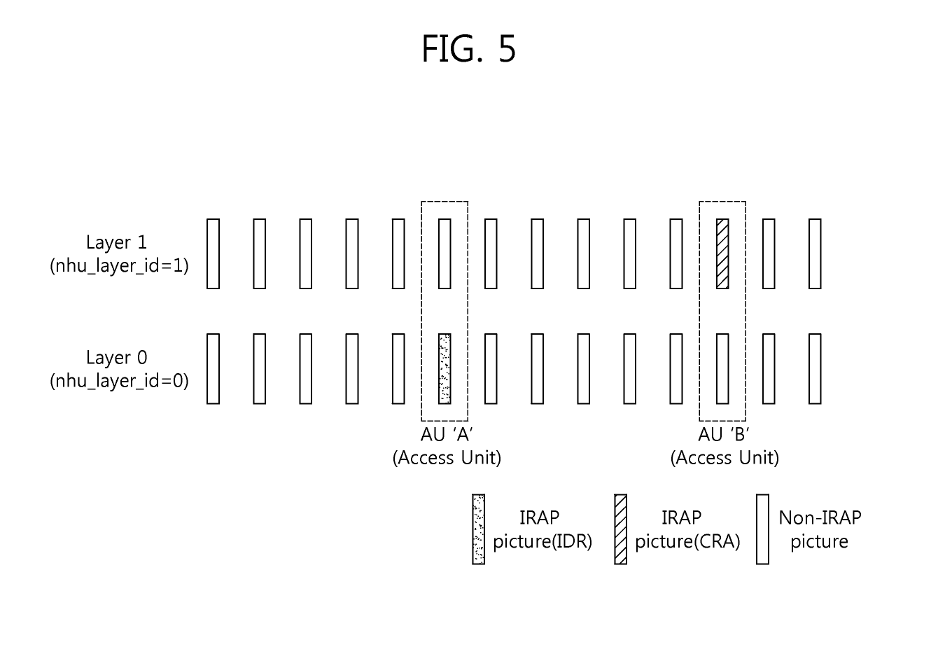

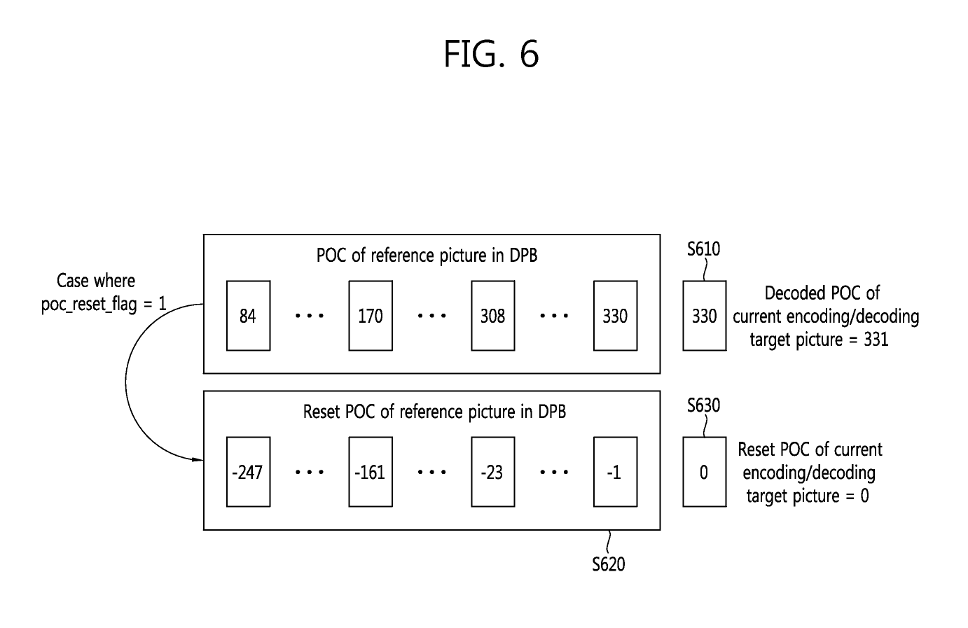

When there is a picture having a POC value different from a POC value of a current picture in the AU, that is, when pictures in the AU have different POC values, the apparatus for video encoding/apparatus for video decoding may reset the POC value so that the pictures in the AU have the same POC value. A process of resetting POC values of pictures in the AU will be described with reference to FIGS. 5 and 6.

FIG. 5 is a diagram illustrating an example of a scalable video structure including a plurality of layers in order to describe a process for resetting POC values of pictures in an AU according to an embodiment of the present invention.

A scalable video shown in FIG. 5 may include an image having a first layer (Layer 0) and a second layer (Layer 1). For example, the first layer (Layer 0) may be a lower layer and the second layer (Layer 1) may be a higher layer. The second layer (Layer 1) may provide scalability higher than that of the first layer (Layer 0).

Referring to FIG. 5, like an AU ‘A’ and an AU ‘B’, an IRAP picture and a Non-IRAP picture are included in the same AU, pictures in the same AU may have different POC values.

In this case, the apparatus for video encoding/apparatus for video decoding may reset POC values of the pictures in the UA so that all pictures in the AU have the same POC value. For example, the apparatus for video encoding/apparatus for video decoding may reset the POC value of the picture as a reset value. The reset value may be ‘0’.

The apparatus for video encoding may signal information indicating that a POC value of the picture is reset as a reset value (for example, 0) in the apparatus for video decoding. For example, the apparatus for video encoding may transmit information indicating whether a POC value of the picture is reset to 0 to the apparatus for video decoding through a slice segment header.

Table 1 and table 2 are an example of a slice segment header syntax for signaling POC reset information indicating whether a POC value of a picture is reset to 0 according to an embodiment of the present invention.

TABLE 1

| slice_segment_header( ) { | Descriptor |
|---|---|
| ... | |
| if( !dependent_slice_segment_flag ) { | |
| i = 0 | |
| if( num_extra_slice_header_bits > i ) { | |
| i++ | |
| if (!cross_layer_irap_aligned_flag) | |
| poc_reset_flag | u(1) |
| } | |
| if( num_extra_slice_header_bits > i ) { | |
| i++ | |
| discardable_flag | u(1) |
| } | |
| ... | |

TABLE 2

| slice_segment_header( ) { | Descriptor |
|---|---|
| ... | |
| if( !dependent_slice_segment_flag ) { | |
| i = 0 | |
| if( num_extra_slice_header_bits > i ) { | |
| i++ | |
| if ( nal_unit_type != IDR_W_RADL && nal_unit_type != | |
| IDR_N_LP ) | |
| poc_reset_flag | u(1) |
| } | |
| if( num_extra_slice_header_bits > i ) { | |
| i++ | |
| discardable_flag | u(1) |
| } | |
| ... | |

Referring to table 1 and table 2, the poc_reset_flag represents whether a POC value of a current picture is reset to 0. For example, when the poc_reset_flag value is 1, it represents that a POC value of the current picture is reset to 0. When the poc_reset_flag value is 0, it represents that the POC value of the current picture is not reset to 0.

The poc_reset_flag may be transmitted through a slice segment header according to a cross_layer_irap_aligned_flag value signaled in a Video Parameter Sets (VPS) extension. For example, when a cross_layer_irap_aligned_flag value signaled in VPS extension is 0, a poc_reset_flag may be transmitted through the slice segment header.

When a picture A of a layer A in the AU is an IRAP picture, the cross_layer_irap_aligned_flag is information indicating that a picture B in the same AU included in a reference layer of the layer A is the IRAP picture. For example, in a case where the cross_layer_irap_aligned_flag value is 1, it may be reported that pictures in the AU are configured as an IRAP picture when there is the IRAP picture in the AU. In this case, all IRAP picture in the same AU may have the same network abstraction layer (NAL) unit type.

When the current picture is an IDR picture, the poc_reset_flag may not be signaled.

When there is no poc_reset_flag, the poc_reset_flag value may be derived as “0”.

The poc_reset_flag may be defined by a protocol so that all slices constituting the picture should have the same value.

Referring back to FIG. 5, an AU ‘A’ includes an IRAP picture (for example, IDR picture) of the first layer (Layer 0) and a non- IRAP picture of a second layer (Layer 1). As described above, since a POC value of the IDR picture is 0, a POC value of the IDR of the first layer (Layer 0) may be derived as 0. As described above, the POC value of the non-IRAP picture of the second layer (Layer 1) may be calculated using an MSB [symbol] and an LSB of the POC value ((1-1), (1-2) methods), and for example, may be derived as a value different from 0. In other words, when at least one picture in the AU ‘A’ in the AU ‘A’ is an IRAP picture and has a POC value of 0 and a POC value of a remaining picture is 0, pictures in the AU ‘A’ have mutual different POC values. Accordingly, the apparatus for video encoding may reset POC values of the pictures in the AU ‘A’, and may set POC reset information (for example, poc_reset_flag) indicating whether POC values of the pictures in the AU ‘A’ are reset to 0 to signal the POC reset information to the apparatus for video decoding through a slice segment header.

For example, since a POC value of an IDR picture of the first layer (Layer 0) in the AU ‘A’ is 0, the apparatus for video encoding does not need to reset the POC value of the IDR picture to 0, and may not set a poc_reset_flag value to 1. Since a POC value of a non-IRAP picture of a second layer (Layer 1) in the AU ‘A’ is not 0, the apparatus for video encoding may reset a POC value of the non-IRAP picture of the second layer (Layer 1) in the same AU and may set a poc_reset_flag value to 1 so that the POC value of the non-IRAP picture of the second layer (Layer 1) is equal to a POC value of the IDR picture of the first layer (Layer 0) in the same AU.

An AU ‘B’ includes a non-IRAP picture of the first layer (Layer 0) and an IRAP picture (for example, CRA picture) of the second layer (Layer 1). As described above, the POC value of the non-IRAP picture of the second layer (Layer 1) may be calculated using an MSB [symbol] and an LSB of the POC value ((1-1), (1-2) methods), and for example, may be derived as a value different from 0. In this case, since the pictures in the AU ‘B’ may have mutually different POC values, the apparatus for video encoding may reset POC values of the pictures in the AU ‘B’′, and may set POC reset information (for example, poc_reset_flag) indicating whether POC values of the pictures in the AU ‘B’ are reset to 0 to signal the POC reset information to the apparatus for video decoding through a slice segment header.

For example, both of a non-IRAP picture of the first layer (Layer 0) and a CRA picture of the second layer (Layer 1) in the AU ‘B’ have a POC value different from 0 and have mutual difference POC values, respectively, the apparatus for video encoding may reset a POC value of a non-IRAP picture of the first layer (Layer 0) and a POC value of a CRA picture of the second layer (Layer 1) to 0, and may set a poc_reset_flag of the non-IRAP picture of the first layer (Layer 0) and the poc_reset_flag of a CRA picture of the second layer (Layer 1) to 1.

Meanwhile, the apparatus for video decoding may receive a slice segment header from the apparatus for video encoding, and may reset a POC value of a current picture to 0 based on POC information (for example, poc_reset_flag) indicating whether a POC value of a current picture parsed from the slice segment header is reset to 0. In this case, when there are reference pictures in a DPB for the current picture, there is a need to further reset POC values of reference pictures in the DPB referred by the current picture by resetting a POC value of the current picture. The apparatus for video decoding may calculate POC values of reference pictures in the DPB in a scheme in an embodiment of FIG. 6.

FIG. 6 is a diagram illustrating a process for resetting a POC value of reference pictures in a DPB based on POC reset information (for example, poc_reset_flag) indicating whether a POC value of a current picture is reset to 0 according to an embodiment of the present invention.

Referring to FIG. 6, when a poc_reset_flag value parsed from the slice segment header is 1, that is, when the POC reset information indicates that a POC value of the current picture is reset to 0, the apparatus for video decoding resets a POC value of a reference picture in the DBP based on a decoded POC value of the current picture.

For example, as described above, the apparatus for video decoding may calculate and decode a POC value of a current picture using an MSB and an LSB of a POC value (the above (1-1) and (1-2) methods) (S610). Next, the apparatus for video decoding may reset POC values of reference pictures in a DPB by reducing the POC values of reference pictures corresponding to a decoded POC value of the current picture (S620), and may reset the POC value of the current picture to 0 (S630).

The apparatus for video encoding/apparatus for video decoding configures a reference picture set for inter-prediction of a current picture based on POC reset information (for example, poc_reset_flag) indicating whether a POC value of the current picture is reset to 0 (S420).

The reference picture set signifies a set of reference pictures of a current picture, and may be configured by reference pictures prior to a current picture in a decoding order. The reference picture may be used for inter-prediction of the current picture.

The reference picture set may include a forward short-term reference picture set PocStCurrBefore referred by the current picture, a reverse short-term reference picture set PocStCurrAfter, a short-term reference picture set PocStFoll which is referred by the current picture, a long-term reference picture set PocLtCurr referred by the current picture, and a long-term reference picture set PocLtFoll which is referred by the current picture.

The apparatus for video encoding/apparatus for video decoding may differently derive a POC value of a reference picture configuring a reference picture set according to POC reset information (for example, poc_reset_flag) indicating whether a POC value of a current picture is reset to 0.

(2-1) When a poc_reset_flag value parsed from the slice segment header is 0 (when the POC reset information indicates that a POC value of a current picture is not reset to 0), the apparatus for video encoding/apparatus for video decoding may calculate POC values of reference pictures referred by a slice configuring the current picture.

In a case of the short-term reference picture, a POC value of the short-term picture may be calculated using a delta_poc value indicating each short-term reference picture signaled from the slice segment header and a decoded POC value of the current picture. In this case, the delta_poc value may be the difference in POC value between the current picture and an i-th short-term reference picture or the difference in the POC value.

In a case of the long-term reference picture, a POC_LSB value or a POC value of the long-term reference picture may be calculated based on a POC_LSB(pocLsbLt[i]) value indicating an LSB of each long-term reference picture POC signaled from the slice segment header and a value delta_poc_msb_cycle_lt for calculating an MSB(POC_MSB) value of each long-term reference picture, and decoded POC value and POC_LSB value of the current picture by a following equation 1.

Although the long-term picture may be basically identified by using only the POC_LSB, there may be reference pictures having the same POC_LSB of the long-term reference picture among reference pictures. In this case, reference pictures may be distinguished from each other by additionally signaling a value delta_poc_msb_cycle_lt for calculating a POC_MSB value of a long-term reference picture.

pocLt=PocLsbLt[i]if(delta_{—}poc_{—}msb_present_flag[i]) pocLt=pocLt+PicOrderCntVal−DeltaPocMsbCyclet[i]*MaxPicOrderCntlsb−slice_pic_order_{—}cnt_{—}lsb [Equation 1]

In the equation, the pocLsbLt[i] represents a POC_LSB value of an i-th long-term reference picture signaled from the slice segment header. The PicOrderCntVal represents a decode POC value of the current picture. The MaxPicOrderCntLsb represents a value signaled from a Sequence Parameter Sets (SPS). The DeltaPocMsbCyCleLt[i] is a value which is derived from the delta_poc_msb_cycle_lt signaled from the slice segment header, and may be derived by a following equation 2.

if (i==0∥i==num_long_term_{—}sps) DeltaPocMSBCycleLt[i]=delta_{—}poc_{—}msb_cycle_lt[i]+DeltaPocMSBCycleLt[i−1] [Equation 2]

else

DeltaPocMSBCycleLt[i]=delta_poc_msb_cycle_{—}It[i]+DeltaPocMSBCycleLt[i−1]

In the equation 2, if(i ==0∥i==num_long_term_sps) means that the i represents a 0-th long-term reference picture or the i is the number of long-term reference picture sets in an SPS.

(2-2) When the poc_reset_flag value parsed from the slice segment header is 1 (when the POC reset information indicates that a POC value of the current picture is reset to 0), the apparatus for video encoding/apparatus for video decoding may calculate POC values of reference pictures referred by a slice configuring the current picture.

In a case of the short-term reference picture, a POC value of the short-time reference picture may be calculated using a delta_poc value indicating each short-term reference picture signaled from the slice segment header and a reset POC value (=0) of a current picture. In this case, the delta_poc value may be the difference in a POC value between the current picture and an i-th short-term reference picture or the difference in a POC value between a (i+1)-th short-term reference picture and an i-th short-term reference picture.

In a case of the long-term reference picture, a POC_LSB value or a POC value of the long-term reference picture may be calculated using a difference poc_lsb(delta_poc_lsb) between a POC_LSB(pocLsbLt) value indicating an LSB of the long-term reference picture POC signaled from the slice segment header and a POC_LSB(slice_pic_order_cnt_lsb) value of the current picture by a following equation 3. The long-term picture may be distinguished based on the PocLt derived by the equation 3.

delta_{—}poc_{—}lsb[i]=PocLsbLt[i]−slice_pic_order_cnt_{—}lsb pocLt=delta_{—}poc_{—}lsb[i]& (MaxPicOrderCntLsb−1) [Equation 3]

In the equation 3, a residual value delta_poc_lsb between the POC_LSB(pocLstLt[i]) of a long-term reference picture signaled from the slice segment header and a POC_LSB of the current picture may have the range of 0 to MaxPicOrderCntLsb-1.

When there are reference pictures having the same POC_LSB(pocLsbLt) of the long-term reference picture among reference pictures, a POC value of the long-term reference picture may be calculated using the poc_lsb(delta_poc_lsb) value derived from the equation 3 and a value delta_poc_msb_cycle_lt for calculating the POC_MSB value by a following equation 4.

if (delta_{—}poc_{—}msb_present_flag[i]) if (delta_{—}poc_{—}lsb[i]<0) pocLt+=−(DeltaPocMsbCycleLt[i]+1)*MaxPicOrderCntLsb [Equation 4]

else

pocLt+−−(DeltaPocMsbCycleLt[i]) MaxPicOrderCntLsb

Although the long-term picture may be basically identified by using only the POC_LSB, there may be reference pictures having the same POC_LSB of the long-term reference picture among reference pictures. In this case, reference pictures may be distinguished from each other by additionally signaling a value delta_poc_msb_cycle_lt for calculating a POC_MSB value of a long-term reference picture.

As described above, the apparatus for video encoding/apparatus for video decoding may calculate a POC value of a reference picture in another scheme according to POC reset information (for example, poc_reset_flag) indicating whether a POC value of the current picture is reset to 0.

The apparatus for video encoding/apparatus for video decoding may configure a reference picture set based on the derived POC value of the short-term reference picture and the POC value of the long-term reference picture, and may perform inter-prediction of the current picture using the reference picture set.

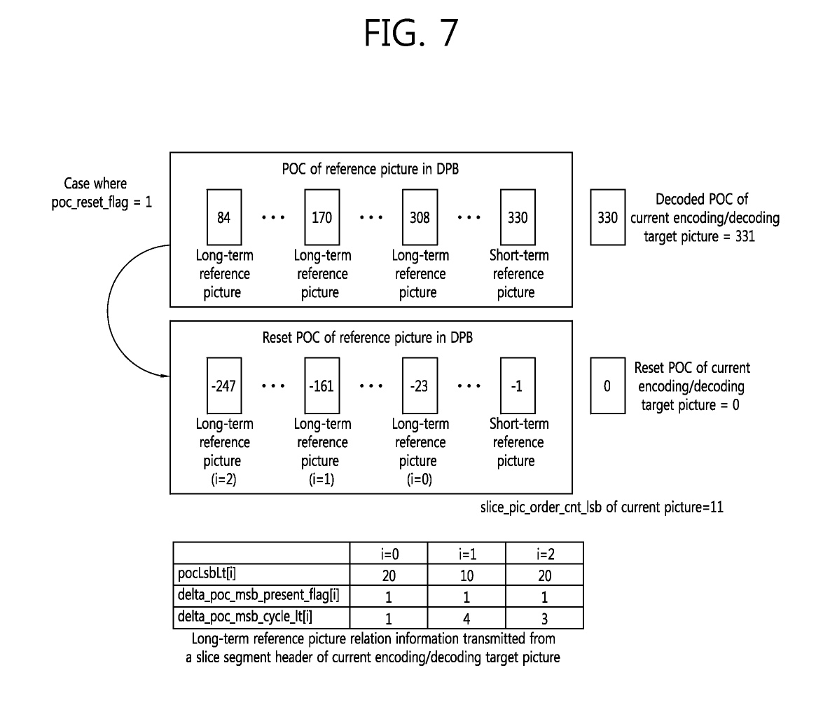

FIG. 7 is a diagram illustrating a method for calculating a POC value of long-term reference pictures according to an embodiment of the present invention.

Referring to FIG. 7, when a poc_reset_flag value parsed from the slice segment header is 1, that is, when the POC reset information indicates that a POC value of the current picture is reset to 0, the apparatus for video decoding may calculate a POC value of the long-term reference picture in a DPB using a POC value and a POC_LSB value, and information associated with the long-term reference picture transmitted from a slice segment header of the current picture.

For example, it is assumed that a poc_reset_flag value of the current picture is 1, and a POC value of the current picture is 331. In this case, a POC of the long-term reference picture corresponding to an (i=2)-th picture in the DBP may be calculated as follows. The POC of the long-term reference picture may be calculated using the equations 3 and 4 described in the above (2-2).

delta_{—}poc_{—}lsb[2]=PocLsbLt[2]−slice_pic_order_{—}cnt_{—}lsb=20−11=9 pocLt[2]=delta_{—}poc_{—}lsb[2]&(MaxPicOrderCntLsb−1)=9 & (32−1)=9, in this case, it is assumed that MaxPicOrderCntLsb is 32.

Since the delta_poc_msb_present_flag is 1, the POC value is calculated using the delta_poc_msb_cycle_lt[i].

Since the delta_poc_lsb[i] is greater than 0, pocLt=pocLt[2]−(DeltaPocMsbCycle)*(MaxPicOrderCntLsb)=9−8*32 =−247, where the DeltaPocMsbCycle may be obtained by the equation 2.

The apparatus for video decoding may reset a POC value of the reference picture corresponding to a (i=2)-th picture in the DBP to −247, and may identify a long-term reference picture corresponding to a (i=2)-th picture from pictures in the DBP as the reset POC value of the long-term reference picture.

The above method according to the present invention may be stored in a recording medium which is fabricated as a program to be executed in a computer and may be read by the computer. For example, the computer readable recording medium includes a Read Only Memory (ROM), a RAM, a CD-ROM, a magnetic tape, a floptical disk, and an optical data storage device, and is implemented in a form of a carrier wave (for example, transmission through Internet).

The computer readable recording medium is distributed in a computer system connected to a network so that a code readable by the computer in a distribution scheme may be stored and executed. Further, a function program, codes and code segments to implement the method may be easily derived by programmers

In the above exemplary systems, although the methods have been described on the basis of the flowcharts using a series of the steps or blocks, the present invention is not limited to the sequence of the steps, and some of the steps may be performed at different sequences from the remaining steps or may be performed simultaneously with the remaining steps. Furthermore, those skilled in the art will understand that the steps shown in the flowcharts are not exclusive and may include other steps or one or more steps of the flowcharts may be deleted without affecting the scope of the present invention.

Although embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. A method for video decoding to support a plurality of layers, the method comprising:
decoding Picture Order Count (POC) reset information indicating whether a POC value of a current picture is reset to 0;
calculating the POC value of the current picture and respective POC values of a long-term reference picture and a short-term reference picture in a decoded picture buffer (DPB) referred by the current picture; and
configuring a Reference Picture Set (RPS) for inter-prediction of the current picture based on the POC value of the long-term reference picture and the POC value of the short-term reference picture.

2. The method of claim 1, wherein the POC value of the current picture is reset to 0 when the POC reset information indicates that the POC value of the current picture is reset to 0.

3. The method of claim 2, wherein the POC value of the short-term reference picture is calculated using the reset POC value of the current picture and a different in the POC value between the current picture and the short-term reference picture when the POC reset information indicates that the POC value of the current picture is reset to 0.

4. The method of claim 1, wherein the POC value of the long-term reference picture is calculated using a difference between a POC Least Significant Bit (LSB) value indicating an LSB of the POC value of the long-term reference picture and a POC LSB value indicating an LSB of the POC value of the current picture when the POC reset information indicates that the POC value of the current picture is reset to 0.

5. The method of claim 4, wherein the POC value of the long-term reference picture is calculated using the difference between the POC LSB value and a value used for determining a Most Significant Bit (MSB) value of the long-term reference picture when reference pictures having a same POC LSB value indicating an LSB of the long-term reference picture is included in the DPB.

6. The method of claim 2, wherein the POC reset information is signaled by an encoding apparatus when an Intra Random Access Point (IRAP) picture and a non-IRAP picture different from the IRAP are in an access unit (AU).

7. The method of claim 6, wherein the current picture comprises the non-IRAP picture included in the AU.

8. An apparatus for video decoding to support a plurality of layers, the method comprising:
a decoder to decode Picture Order Count (POC) reset information indicating whether a POC value of a current picture is reset to 0; and
a predictor to calculate the POC value of the current picture and respective POC values of a long-term reference picture and a short-term reference picture in a decoded picture buffer (DPB) referred by the current picture, and to configure a Reference Picture Set (RPS) for inter-prediction of the current picture based on the POC value of the long-term reference picture and the POC value of the short-term reference picture.

9. The apparatus of claim 8, wherein the POC value of the current picture is reset to 0 when the POC reset information indicates that the POC value of the current picture is reset to 0.

10. The apparatus of claim 9, wherein the POC value of the short-term reference picture is calculated using the reset POC value of the current picture and a different in the POC value between the current picture and the short-term reference picture when the POC reset information indicates that the POC value of the current picture is reset to 0.

11. The apparatus of claim 8, wherein the POC value of the long-term reference picture is calculated using a difference between a POC Least Significant Bit (LSB) value indicating an LSB of the POC value of the long-term reference picture and a POC LSB value indicating an LSB of the POC value of the current picture when the POC reset information indicates that the POC value of the current picture is reset to 0.

12. The apparatus of claim 11, wherein the POC value of the long-term reference picture is calculated using the difference between the POC LSB value and a value used for determining a Most Significant Bit (MSB) value of the long-term reference picture when reference pictures having a same POC LSB value indicating an LSB of the long-term reference picture is included in the DPB.

13. The apparatus of claim 9, wherein the POC reset information is signaled by an encoding apparatus when an Intra Random Access Point (IRAP) picture and a non-IRAP picture different from the IRAP are in an access unit (AU).

14. The apparatus of claim 13, wherein the current picture comprises the non-IRAP picture included in the AU.
